(19) United States
(12) Patent Application Publication
(10) Pub. No.: US 2011/0309746 A1
(43) Pub. Date: Dec. 22, 2011

(54) MODULAR LIGHT EMITTING DIODE SYSTEM FOR VEHICLE ILLUMINATION

(75) Inventors: David P. Eckel, Fort Salonga, NY (US); Kevin Lawrence, Port Jefferson Station, NY (US); Gannon T. Gambeski, Saint James, NY (US); Seckin K. Secilmis, Seaford, NY (US); Vincent S. Cipolla, Smithtown, NY (US); Michael Glater, Brooklyn, NY (US); Glenn Thomas Schmidt, Selden, NY (US)

(73) Assignee: B/E Aerospace, Inc., Wellington, FL (US)

(21) Appl. No.: 13/164,008

(22) Filed: Jun. 20, 2011

Related U.S. Application Data
(60) Provisional application No. 61/356,367, filed on Jun. 18, 2010.

(51) Int. Cl. B60Q 1/14; H05B 37/02

(52) U.S. Cl. 315/77; 315/294; 315/297

(57) ABSTRACT

A light emitting diode (LED) unit is therefore provided, comprising: an LED module, comprising: a plurality of LEDs; LED drive circuitry that drives the LEDs; an LED control bus that carries LED illumination control information to the LED drive circuitry; and a housing that at least partially surrounds LED module components; a power supply and control module, comprising: a power supply that converts a first voltage level to a second voltage level; a microcontroller that receives illumination instructions from an external source; an LED drive controller that receives lighting instructions from the microcontroller and transmits LED illumination information to the LED drive circuitry; a housing that at least partially surrounds power supply and control module components; an interface that connects the LED drive controller to the LED control bus.

### CROSS-REFERENCE TO RELATED APPLICATIONS

The present application claims the benefit of U.S. Provisional Application No. 61/356,367, filed Jun. 18, 2010, entitled, “Modular Light Emitting Diode System with Temperature Sensor for Vehicle Illumination”, herein incorporated by reference.

The subject matter of this application is also related to the subject matter of one or more of the following U.S. patent application Ser. Nos., herein incorporated in their entirety by reference:
Ser. No. 12/101,377, filed Apr. 11, 2008;
61/099,713, filed Sep. 24, 2008;
61/105,506, filed Oct. 15, 2008;
Ser. No. 12/566,146, filed Sep. 24, 2009;
61/308,171, filed Feb. 25, 2010;
61/320,545, filed Apr. 2, 2010;
61/345,378, filed May 17, 2010; and
61/492,125, filed Jun. 1, 2011.

### BACKGROUND

Vehicle lighting, particularly aircraft lighting, has transitioned from incandescent lighting to fluorescent lighting, and is again transitioning to light emitting diode (LED) lighting, particularly in light of advances made in the field of LEDs which permit a much higher light output. LED lighting has numerous advantages over incandescent and fluorescent lighting—it is lightweight, relatively simple to drive, low power, and efficient. These characteristics make LED lighting ideal for vehicles where weight is a concern.

Although newer vehicles will be designed around the advances in LED technology, many existing vehicles with years of service life remain, and therefore it is advantageous to replace existing fluorescent lighting with LED lighting, as described, e.g., in U.S. patent application Ser. No. 12/101,377, so that the existing circuitry, wiring, etc., is minimally disrupted. Additionally, a modular design is desirable in order to facilitate manufacturing, installation, maintenance, and repair.

### SUMMARY

A lightweight and relatively inexpensive LED light unit is provided as a base for a vehicle lighting system that can be implemented and integrated into a vehicle design with minimal impact.

In general, the lighting units are designed to provide a simple low cost and low weight lighting solution taking a focus on the use of the latest LED technology, with minimized power consumption, long lifetime, and high reliability. The description below provides details about various exemplary embodiments of the invention.

The lighting unit designs are weight optimized with low power consumption and are also preferably designed to use the existing lighting interfaces on an aircraft or other vehicle and be direct replacements for the existing lighting units without significant alteration of existing wiring, connectors or mounting points. The replacement process for these units is designed to be easy, fast, and foolproof.

In an embodiment, a modular light emitting diode system having a temperature sensor within individual light modules provides illumination for the interior of a vehicle. The modules provide flexibility in color (for color LED modules) and illumination control, and to replace existing modules in aircraft or other vehicles that utilize incandescent, fluorescent, or other forms of lighting.

Although the system described herein is an exemplary embodiment designed for use in an aircraft, it should be noted that this system can be utilized in any vehicle and therefore use of the term “aircraft” is defined herein as a proxy for the more general term “vehicle”.

Color and white lighting designs preferably have the same physical and electrical interfaces and are interchangeable so the use of color or white lighting can be an easy customer choice with little impact on the production line.

A light emitting diode (LED) unit is therefore provided, comprising: an LED module, comprising: a plurality of LEDs; LED drive circuitry that drives the LEDs; an LED control bus that carries LED illumination control information to the LED drive circuitry; and a housing that at least partially surrounds LED module components; a power supply and control module, comprising: a power supply that converts a first voltage level to a second voltage level; a microcontroller that receives illumination instructions from an external source; an LED drive controller that receives lighting instructions from the microcontroller and transmits LED illumination information to the LED drive circuitry; a housing that at least partially surrounds power supply and control module components; an interface that connects the LED drive controller to the LED control bus.

A vehicle LED illumination system, is also provided comprising a plurality of LED units, as discussed above; wherein a plurality of the LED units are controlled by a single external controller that is connected to a cabin communication system (CCS).

TABLE OF ACRONYMS

| | |
|---|---|
| ANSI | American National Standards Institute |
| AP | access panel |
| AWG | American wire gage |
| BIT | built-in tests |
| BITE | built-in test equipment |
| CCS | cabin communication system |
| CIE | International Commission on Illumination |
| LC | lighting controller |
| LED | light emitting diode |
| LRU | line-replaceable unit |
| PA | passenger address |
| PWM | pulse width modulation |
| RGBW | red green blue white |
| VAC | volts-alternating current |
| VDC | volts-direct current |

### DESCRIPTION OF THE DRAWINGS

Various embodiments of the invention are illustrated in the drawings and discussed in more detail below.

FIG. 1A is a bottom perspective view of an embodiment of a light unit attached to vehicle mounting elements;

FIG. 1B is a top perspective view of the embodiment of a light unit shown in FIG. 1A;

FIG. 2A is a bottom perspective view of another embodiment of a light unit attached to vehicle mounting elements;

FIG. 2B is a top perspective view of the embodiment of a light unit shown in FIG. 2A;

FIG. 2C is an alternate bottom perspective view of the embodiment of a light unit shown in FIG. 2A;

FIG. 2D is a side view of the embodiment of a light unit shown in FIG. 2A;

FIG. 2E is an end view of a module connector;

FIG. 2F is a perspective view of the power supply and control unit;

FIG. 2G is a side view of the power supply and control unit;

FIG. 2H is an end view of the power supply and control unit;

FIG. 3A is a block diagram of an aircraft lighting system using the LED units;

FIG. 3B is a block diagram of an exemplary LED unit;

FIG. 3C is a block diagram of another exemplary LED unit;

FIG. 4 is a block diagram of an LED unit with multiple LED modules;

FIGS. 5A-C are CIE Chromaticity Diagrams; and

FIGS. 6-12 are various aircraft fuselage cross sections showing LED unit placement.

### DETAILED DESCRIPTION

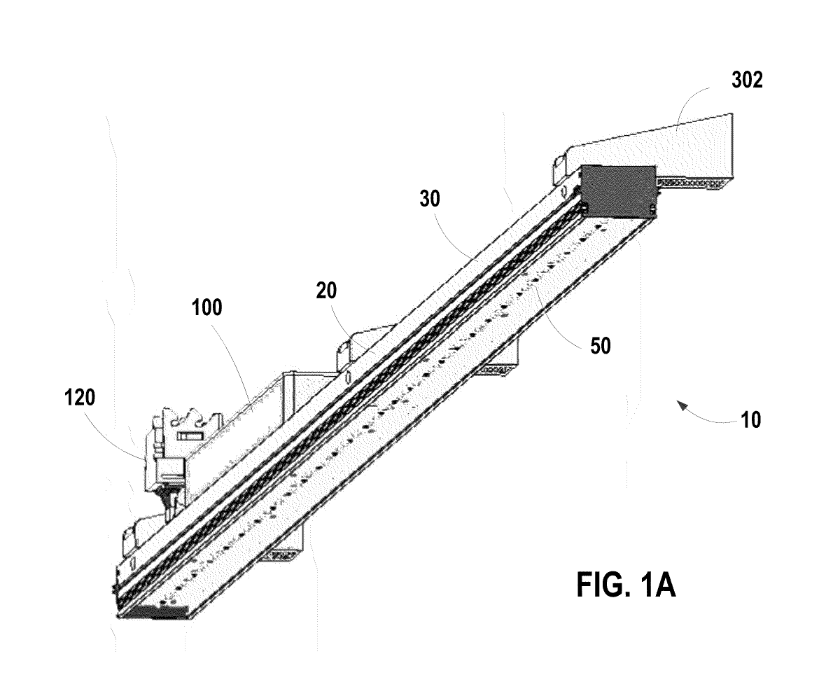

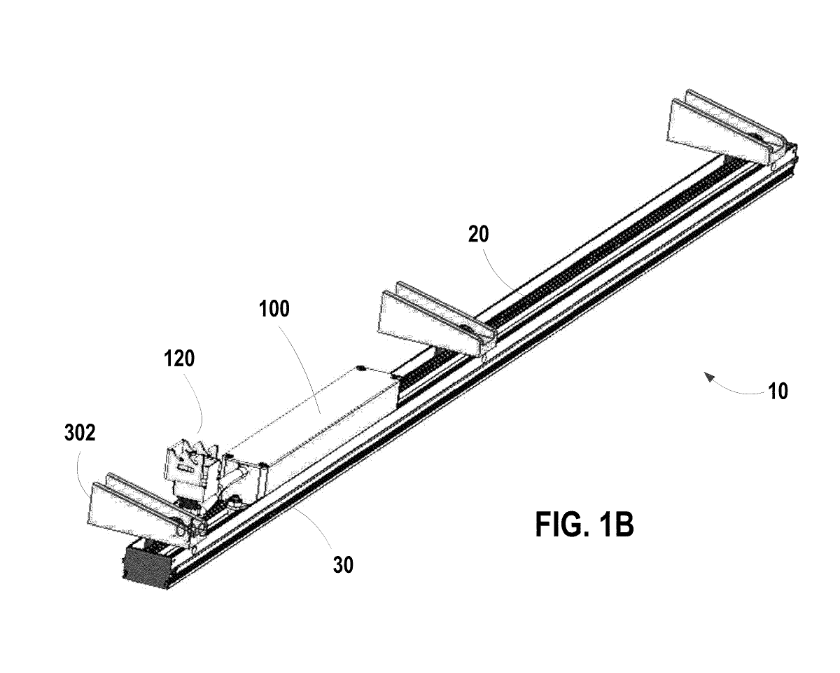

FIG. 1A is a bottom perspective view of an exemplary LED unit 10. The units 10 may vary in terms of their length, but preferably are manufactured in a standardized set of lengths. The mechanical interface to the aircraft can be independent from the installation environment and equivalent for each length of LED unit. Each variant can provide a number of attachment points to accommodate symmetrical mechanical mountings, discussed in more detail below. The position of the electrical connector to aircraft power and cabin communication system (CCS) interface may be adaptable to either left- or right hand end of the LED unit 10.

A row of LEDs 50 is provided (bottom of the unit shown). In one embodiment, colored LEDs are used that can be used to produce essentially any color or intensity of illumination. In another embodiment, only white LEDS or white and amber LEDs are used. The LEDs may be grouped into strips.

The LED unit 10 comprises a power supply and control unit 100 that is preferably affixed to the top of the housing 30 of the LED module 20 that contains the LEDs 50 themselves. The housing 30 is preferably made of a lightweight metal, such as aluminum. A module connector 120 is provided that permits connection of the module to the vehicle power and communications system. The unit 10 may be mounted to vehicle mounting elements 302 (which do not form a part of the unit 10). FIG. 1B is a top perspective view of the unit 10 shown in FIG. 1A, and this view further illustrates a module connector cable 122 that interfaces the connector 120 with the electronics of the power supply and control unit 100.

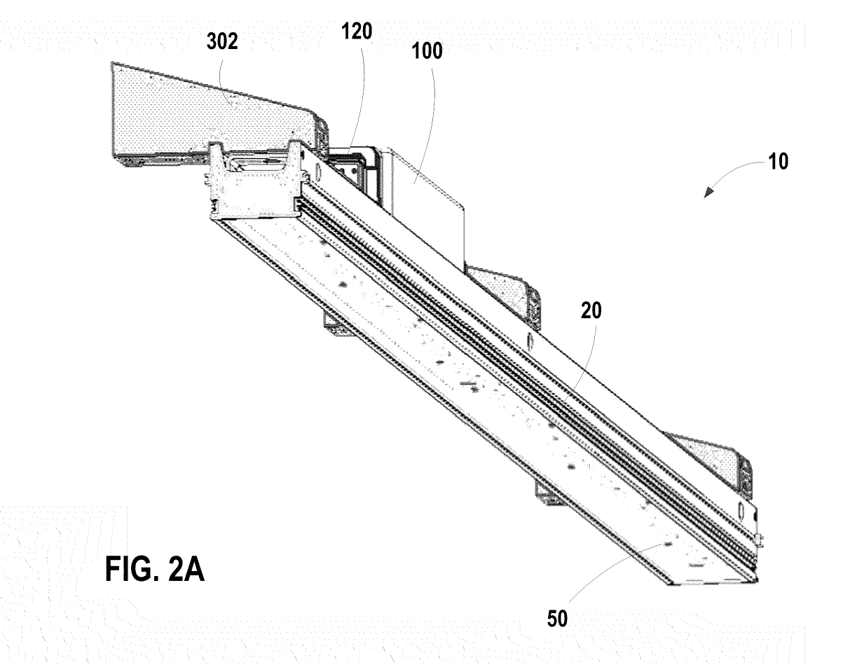

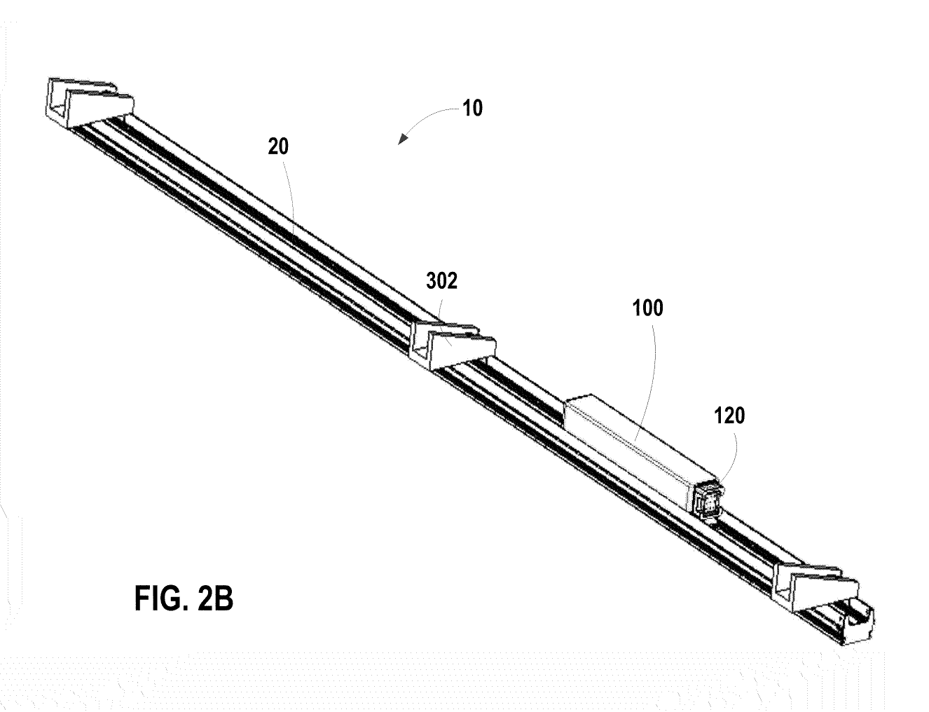

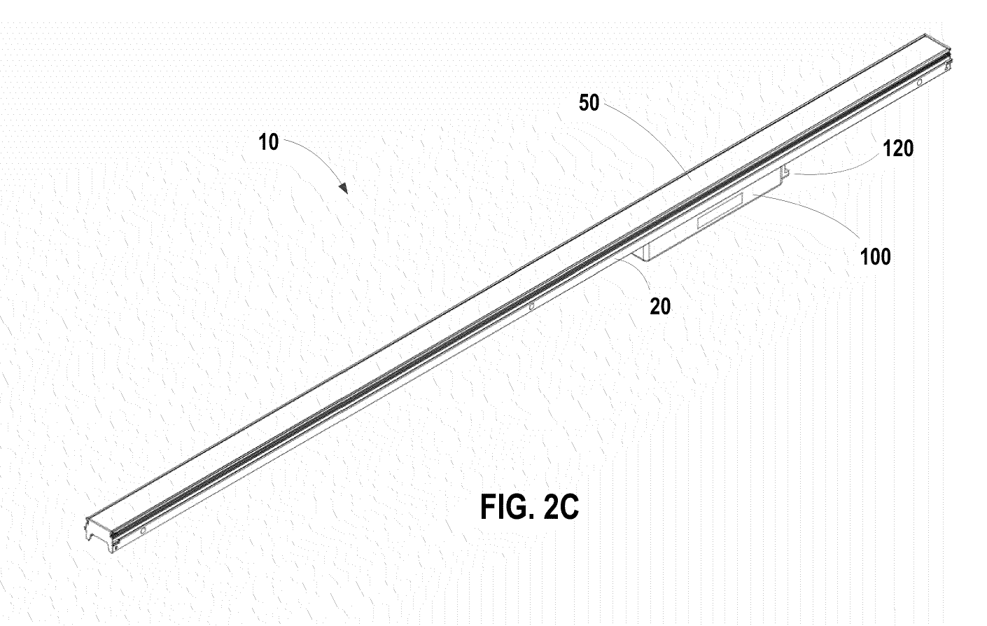

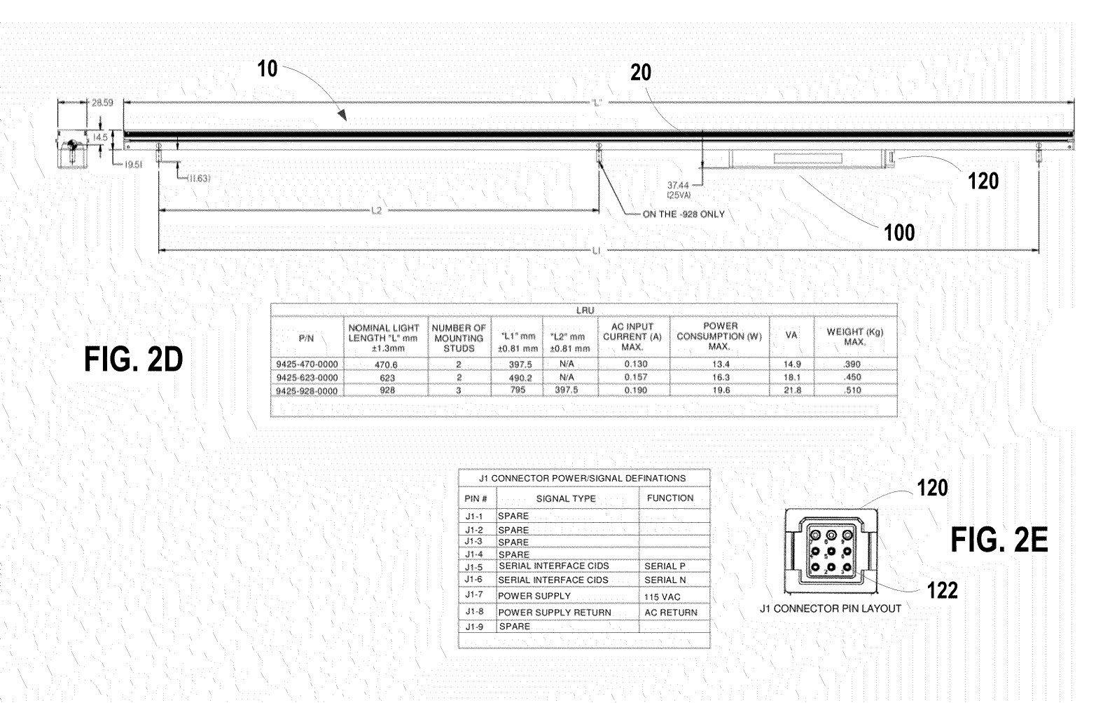

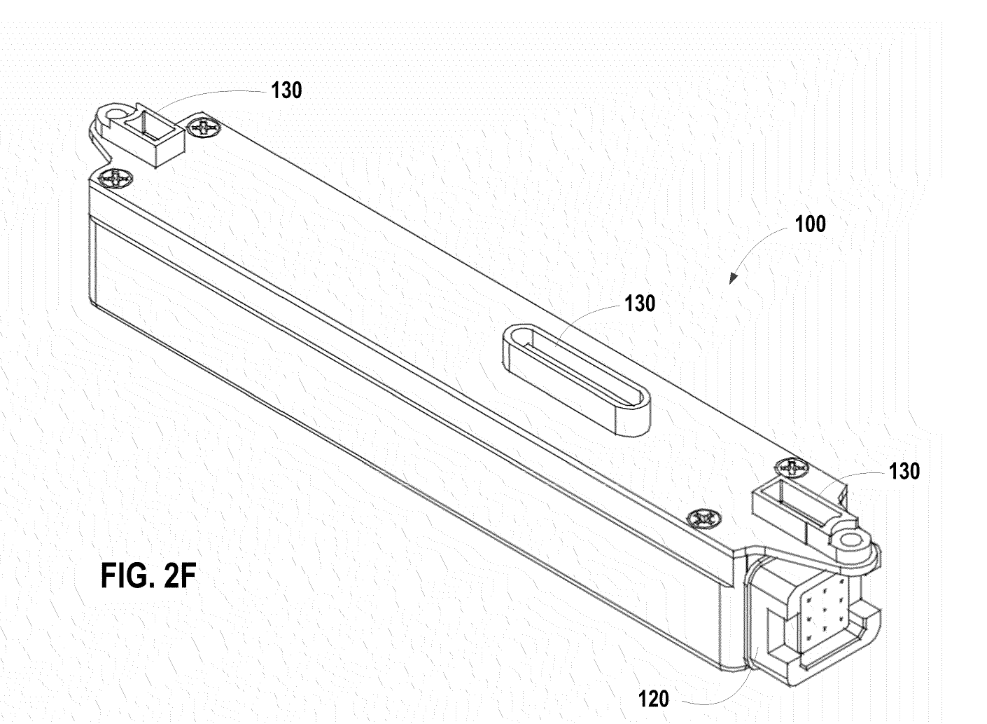

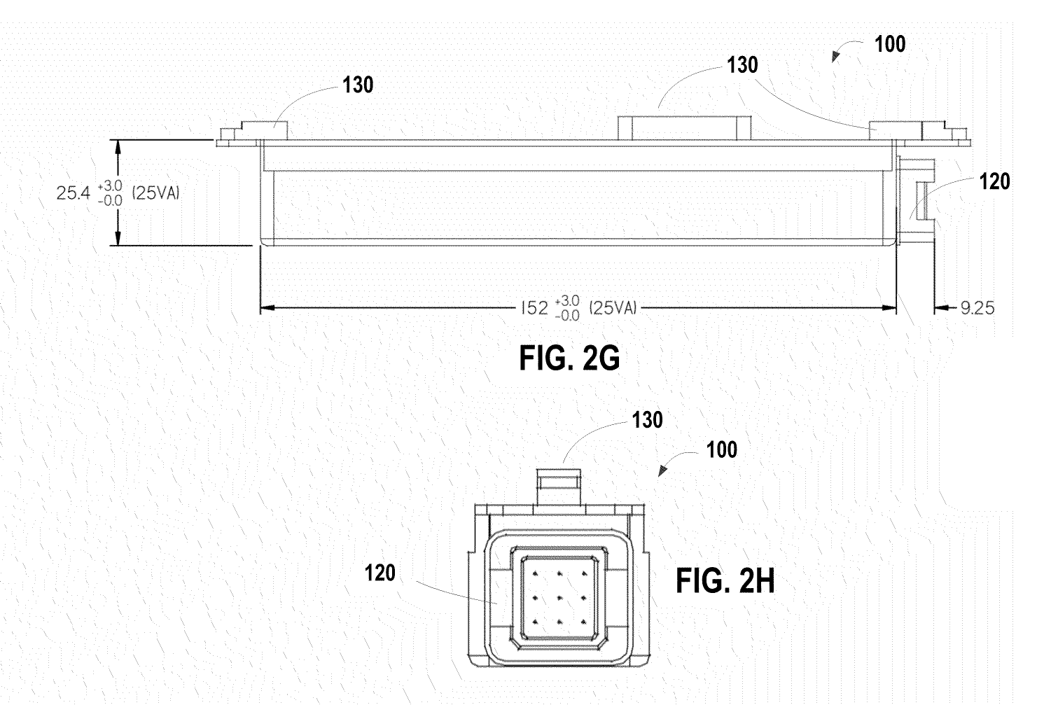

FIGS. 2A-D show another embodiment in which the connector 120 does not use a connector cable 122 that extends outside of the power supply and control unit 100. FIG. 2D provides nominal lengths for components of three exemplary LED unit 10.

FIG. 2E shows an exemplary connector 120 pinout, which includes a serial interface to the CCS, power supply, and power supply return. FIG. 2F is a top perspective view of the power supply and control unit 100 shown in FIGS. 2A-D. In addition to providing a more detailed illustration of the control unit 100, it further illustrates attachment elements 130.

FIG. 2G is a side view of a shorter-length exemplary unit 10 and showing the attachment elements 130. FIG. 2H is an end-view of the module, showing the module connector 120.

Variations on embodiments of the LED modules 10, discussed in more detail below, include (but are not limited to) size of the module, the plug configuration (i.e., with or without an exterior cable 122 extending to the module connector), compensated or uncompensated, and color or white LEDs. The compensated and uncompensated distinction relates to the fact that LEDs can vary in color and intensity based on manufacturing variables, operating temperature and age. Compensated LED modules 10 are typically color modules in which calibration prior to installation has been performed and then calibration and adjustment information is stored either within the module or within a control system of the vehicle. In these designs, high level color information can be provided to the unit 10 and the appropriate modifications can be made to ensure that the color within a unit 10 and between modules does not vary to an extent that it would be readily detectable by a passenger.

However, the compensation, calibration, and circuitry necessary to achieve this introduces additional costs—therefore, it may be desirable, particularly when white LEDs are desired, to eliminate the additional overhead hardware and production costs. A lower-end design is intended to be a simple low cost design architecture that deploys hardware and software/firmware with a fixed white color temperature.

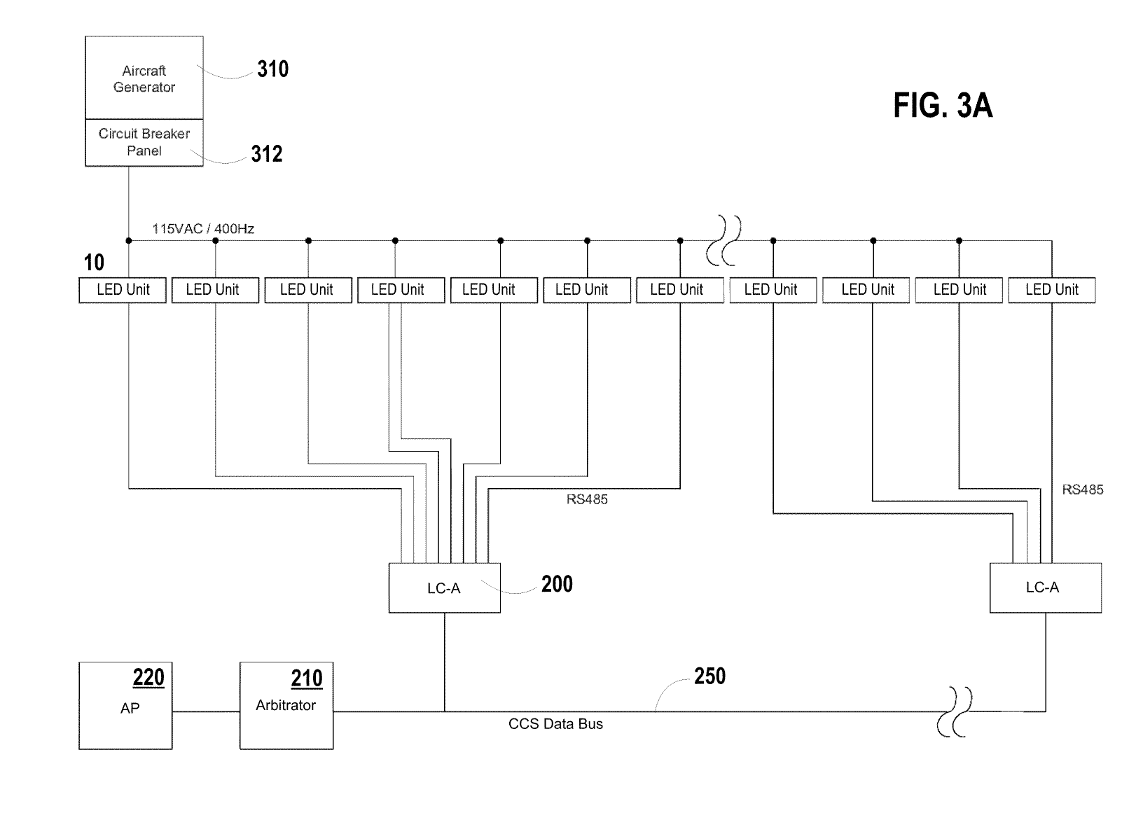

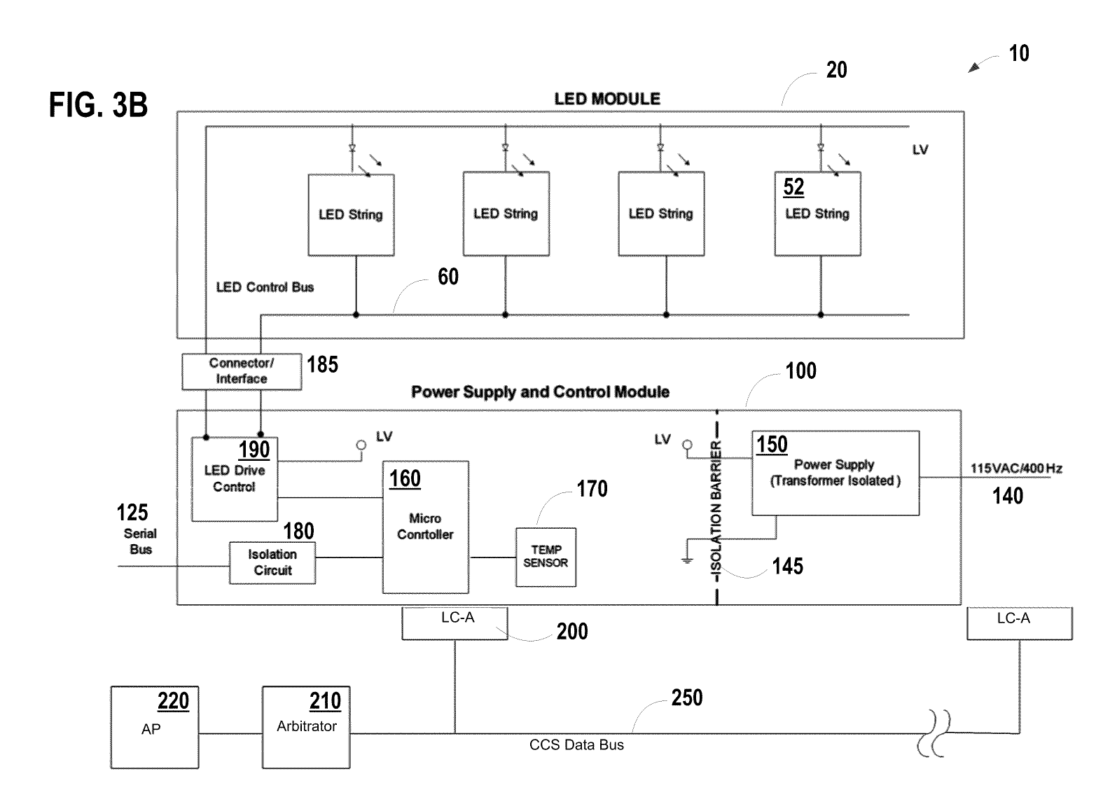

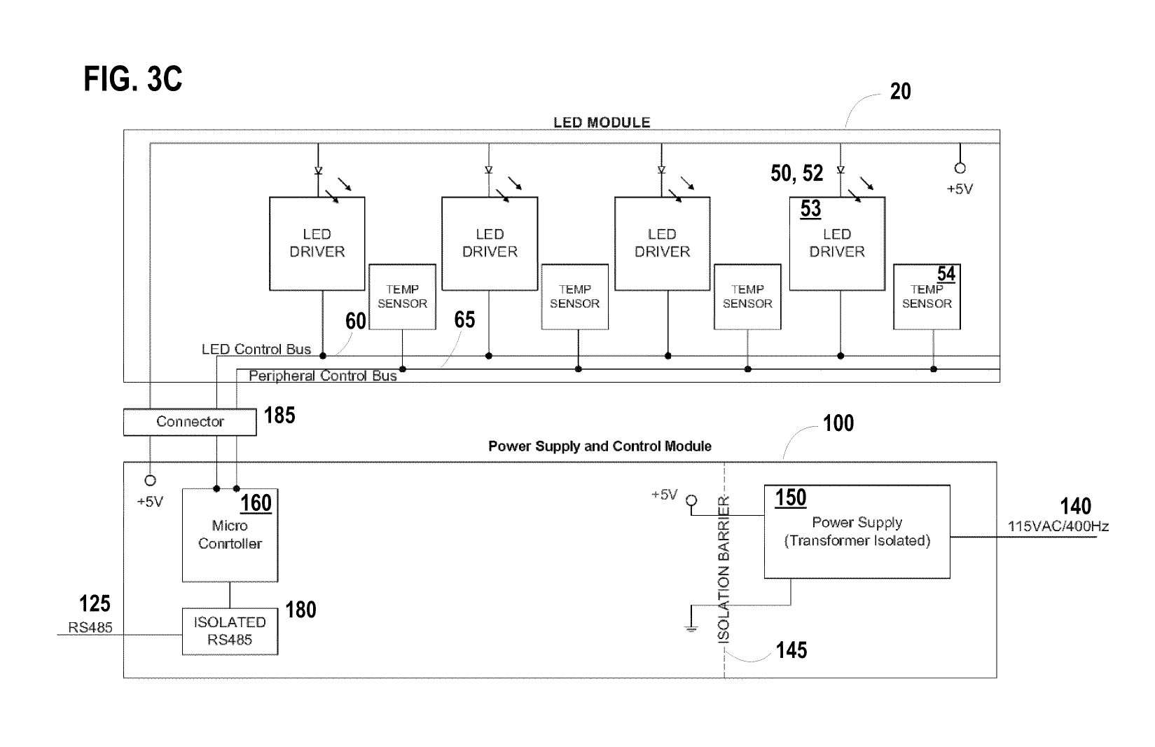

FIG. 3A is a system logical block diagram illustrating an exemplary architecture using a series of compensated or uncompensated LED units 10, each of which could be the module(s) illustrated in FIGS. 1A through 2H. As can be seen in FIG. 3A, the vehicle/aircraft power generator 310 can connect to the LED units 10 via a circuit breaker panel 312. The LED units 10 are preferably configured to be utilized with aircraft control equipment and 115 VAC 400 Hz power. An LED module controller (LC-A) 200 is preferably designed to control up to eight LED units 10, and each LED unit 10 receives commands from a controller LC-A 200.

In this arrangement, each LED unit 10 can have own primary power connection and dedicated serial communications, e.g., RS485 control signals. An LED unit 10 can also be configured with two independent control signals. Since, in an embodiment, each control signal path is dedicated, there is no need for addressing switches or pin programming in an LED unit 10. The controller LC-A units 200 transmit commands to the LED units 10 and may receive information about their health.

In the embodiment shown, the communication architecture between the LED unit 10 and controller LC-A 200 are master-slave, where the controller LC-A 200 is the master and the LED unit 10 is the slave. However, other configurations are possible, such as a peer-to-peer architecture. In this design, daisy-chaining of communication (and power) through the LED unit 10 is not required. In this embodiment, each LED unit 10 preferably has a dedicated RS485 connection, although, as noted above, an LED unit 10 can have two dedicated RS485 ports. In this configuration, the LED units 10 do not require addressing. However, it is also possible to provide some form of addressing for the LED units 10.

FIG. 3B is a block diagram illustrating an exemplary unit 10 that can be used in the system. An LED unit 10 may comprise an LED module 20 which houses the LEDs 50 that may be organized into LED strings 52, and a power supply and control module 100 that are connected together via a connector/interface 185.

The LED module 20 comprises a case/housing 30 that contains a plurality of LEDs 50 or LED strings 52, with their respective drivers. An LED control bus 60 provides control signal information to the LED strings. The LED control bus 60 is connected to the power supply and control module 100 via the connector/interface 185.

The power supply and control module 100 receives the line voltage 140 at 115 VAC/400 Hz at its power supply 150. An isolation barrier 145 can be used to isolate the aircraft mains voltage of 115 VAC from the module/line level voltage LV, which is what the modules 20, 100 run on.

In a configuration in which there is no chassis ground connection available, an embodiment is provided in which the 115 VAC/400 Hz power supply module 150 in all units resides in a plastic housing to prevent shock hazard. Its low voltage (e.g., less than 30 VDC or VAC) output is passed to the control circuitry within the power supply module and then onto the LEDs 50 in the aluminum housing 30. The aluminum housing 30 houses the LEDs 50 and associated circuits—it is not grounded and is normally floating. Two power supplies, e.g., may be considered: one low power (˜25 VA) and one high power (˜50 VA), and can be used as required. These power supplies may be galvanically isolated from the other electronic parts and may be used for larger and/or for longer LED units 10.

It is known that the light output of an LED can vary, for a given voltage or current input, based on the temperature. In other words, a precisely controlled voltage or current cannot ensure a precisely controlled illumination if the temperature is allowed to vary. Therefore, if precise control of illumination is desired, it is desirable to monitor the temperature so that appropriate temperature-based adjustments can be made.

FIG. 3B provides an example in which a temperature sensor 170 is provided within the power supply and control module 100. The temperature sensor 170 provides input into the microcontroller 160 which can use the temperature information for adjusting the amount of drive provided by the LED drive control 190. For example, the microcontroller 160 may have access to information about the LEDs 50 or LED strings 20, possibly based on previous testing and calibration data at a particular temperature, e.g., 25° C., and it may also utilize either a formula or additional data obtained during calibration to know how to compensate the delivered power in order to maintain the brightness and color at, e.g., 35° C.

It is possible to calibrate an LED 50 or a group/string of LEDs 52 so that the light output characteristics can be know for a range of voltages or currents and for a range of temperatures. This could be determined, e.g., by a pre-installation calibration procedure that applies variations of voltage or current and temperature and then measures the light output. The input and output variables can then be stored in a table and associated with an LED 50 or a group of LEDs 52 so that the LEDs can be precisely controlled.

It is possible that the temperature even within an LED unit 10 could vary based on a number of factors, such as a temperature gradient at the location the unit is placed, uneven heating at certain locations, etc. Therefore it is desirable to know the specific temperature near the LED or LED group for more precise control.

As is illustrated in FIG. 3C, each LED and driver 53 or LED strings 50, 52 have their own associated temperature sensor 54. However, it is also possible to use fewer sensors to sample temperatures of a broader area.

As also illustrated in FIG. 3C, the LED unit 10 may comprise both an LED control bus 60 via which the LED drivers receive signals for controlling the illumination of an LED and a peripheral control bus 65 the permits an information flow with the micro controller 160.

As can be seen in FIGS. 3B, 3C, a access panel 220 can be used to instruct an arbitrator 210, which serves as an interface between a flight attendant panel and lighting controller, to communicate lighting information to the units 10 through the controller LC-A 200, preferably over the CCS data bus 250. A serial bus 125 that connects to the microcontroller 160 through an isolation circuit 180 can be used to join units 10 together and to communicate relevant information.

Although the LED module 20 and the power supply and control module 100 can each have their own separate housing, it is also possible to contain them both within a same housing.

As can be seen, in a preferred embodiment, the power supply module 100 is provided with a standard aircraft 115 VAC/400 Hz main supply voltage 140. The voltage can be adjusted to, e.g., 5 VDC (or VAC) to power the LED module 20.

The voltage conditioning circuitry associated with the power supply 150 may utilize an isolating transformer as the mechanism to step the voltage down. The transformer may utilize different core materials, such as silicon steel, metglas, and nanocrystalline, depending on cost vs. performance criteria, the latter two materials having lower core losses, but higher cost.

In a preferred embodiment, the following specifications for the transformer may be utilized:
Nominal Voltage Input: 115 Vrms
Nominal Frequency: 400 Hz
Input Voltage Range 97 to 132 Vrms
Secondary Power Output: 20 watts
Secondary Voltage Output: 33 Vrms (function of DC to DC converter for maximum efficiency)
DC Output Voltage: 5
Dielectric Strength >>1 KV
Efficiency=>95%
Total Transformer Losses <1.5 watts

In a preferred embodiment, the transformer may have a L×W×H of 3.44″×0.816″×0.763″, and weigh 0.37 lbs., +case+potting. It is desirable to maintain the average power factor, without power factor compensation, to be approximately 0.85 to 0.9 at full load, although increasing the power factor beyond this could be achieved by utilizing active power factor correction (e.g., a single chip solution).

FIG. 3C shows a microcontroller 160 that is connected to the peripheral bus 65 and the LED control bus 60 to obtain feedback and provide control signals to the LED drivers 53. This module may communicate with external controllers via a communications link, such as RS485 125.

As illustrated, the power supply modules may be rated at various power ratings depending on application. The power supply output voltage can be varied to account for LED Vf variation and LED thermal Vf variation. The LED unit ideally carries a low voltage DC (+5V), while the LED drivers 53 may be constant current sources. In a preferred embodiment, the LED drivers 53 refresh the LEDs at a frequency of at least 150 Hz. The temperature sensors 54, 170 are primarily used for color correction of light due to thermal effects.

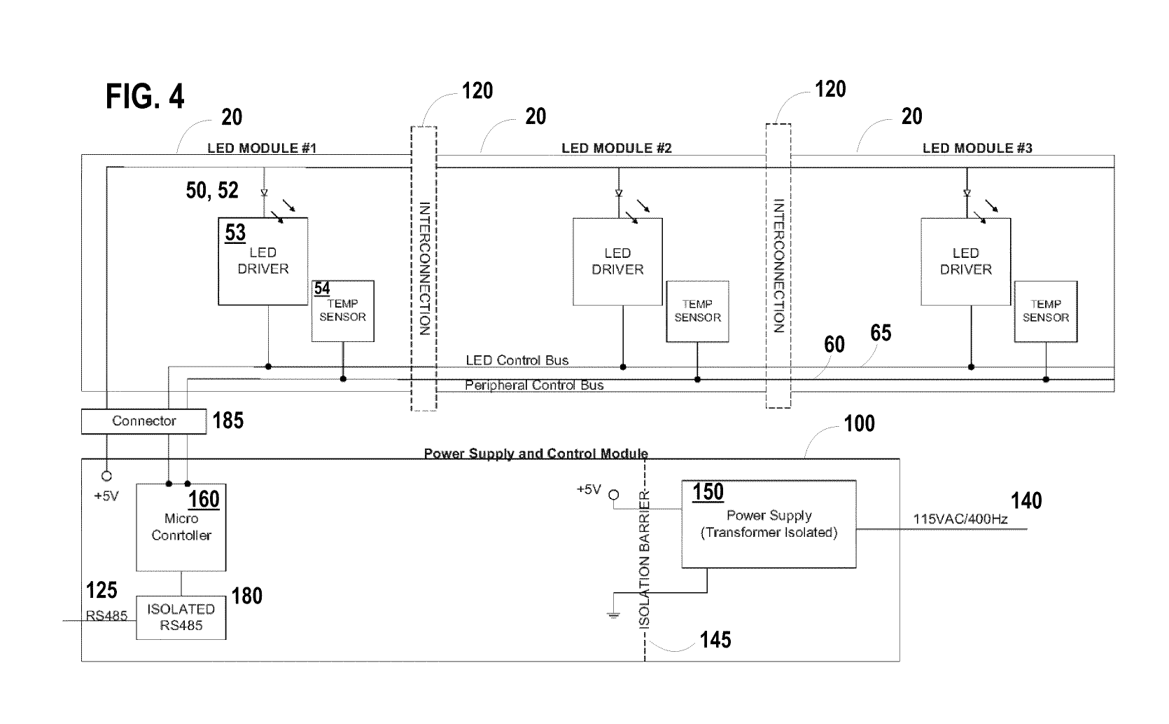

FIG. 4 is a block diagram illustrating an embodiment in which a power supply and control module 100 that controls a plurality of LED modules 20, the LED modules 20 being interconnected to one another with another via an interconnection 120. The LED modules 20 each have their own identifier, and the microcontroller 160 is able to address each LED module 20 individually using the identifier.

This shows how the LED unit 10 can be expanded by adding modular sections 20. Communications and logic signals are passed from one LED module 20 to the next, but the controller 160 can individually address each module 20. There is just one integrated power supply with control module 100 per LED unit including the two port type XIII LED unit. In this embodiment, only one power supply 150 is needed per LED module 20. Each LED module 20 can connect to another, and LED modules 20 can be daisy chained together. All communications and logic may be passed from one LED board to the next, and each communicates back with the microcontroller 160 in the power supply and control module 100.

In more detail, in an embodiment, for LED control, feedback, and over temperature protection, LED drivers 53 can pulse current greater than the required 150 Hz to minimize perceived flicker to the passengers and crew. The step response time between any two consecutive dim steps is preferably 0.4 s±0.1 s. Heat generated by the LEDs 50 and other components are measured by temperature sensor(s) 54 that feed into the LED unit microprocessor 160. The microprocessor 160 in turn regulates the duty cycle of current pulses to the LEDs to maintain the temperature of the LED module 20 to be within the desired operating range. This approach is further integrated with corrective algorithms and methods that enable the LED unit 10 to adjust the photometric performance and light output to maintain the desired intensity and color as the LEDs age.

The output color and luminance of the LED unit 10 can be controllable via the CCS 250. The CCS 250 is a microprocessor controlled data bus system for the control, operation and testing of passenger address (PA), cabin interphone, passenger call, passenger lighted signs, general illumination and emergency evacuation signaling. It includes apparatus that permits the pilot and flight attendants to make audio communication with the passengers and to activate certain visual signaling apparatus. For example, a pilot wishing to make an audio announcement to the passengers activates the public address microphone which emits a signal in digital form. An encoding/decoding device, converts this signal into analog format which it then transmits through the CCS 250 to the PA loudspeaker. The same process enables the pilot or flight attendant to turn control certain equipment within the aircraft.

The LED unit processor 160 can provide built-in tests (BIT) comparable to that of the older fluorescent lighting units. In such configurations, the processor 160 performs power-up BIT upon startup, at which time the processor 160 checks operations of its memory, the LED drivers 53, and the temperature sensors 54, 170. The luminous intensity of the LED unit 10 can be varied to control the LED temperature in a manner which will not be noticeable to the human eye. In addition, a thermal switch may be used in the power supply 150 to independently shut down the power supply when its operating temperature exceeds a safe limit, such as for ground survival.

BIT features may be added to provide more status information via the CCS interface. These features may include operational metrics such as communications statistics, LED operational life data, and a time stamped event log, or configuration data such as serial numbers, part numbers and HW/SW revision levels. BITE (Built in Test Equipment) can be deployed that offers software/firmware redundancy, fault isolation and monitoring, etc. BITE (Built in Test Equipment) can be deployed that offers a full replication of all software/firmware and hardware in case of a complete loss of the microcontroller and associated hardware. This may include additional temperature sensors and other support circuitry.

In a preferred architecture, the controller LC-A 200 is the bus master and the LED unit 10 is a slave. This means that the LED unit 10 reports its health only when polled by the controller LC-A 200. When polled, the LED unit processor 160 reports its current health state by retrieving data from the LED unit 10, possibly including:

1) CRC check

2) Temperature sensor failure

3) Watchdog timer counter

4) RAM checksum failures

5) Downloaded color scene data with non-matching CRC

Maintenance personnel can thus review health reports from all LED unit 10 equipment using a access panel (AP) 220 to access corresponding readouts.

In an embodiment, if there is no communication from the controller LC-A 200 for more than some predetermined amount of time, e.g., sixty seconds, the LED unit 10 sets the LED drivers 53 to a default value, tentatively 50 percent of full illumination, according to the fail safe mode setting, as appropriate. Upon detection of resumed commands, the LED unit 10 reverts to normal operation. Also, each LED unit 10 can have built-in fuse(s) in case of an internal short.

The LED unit 10 is a flexible design architecture that can utilize hardware and firmware to enable customer selectable white color temperatures either before, during or after the time of the installation. The LED unit power supply 150 supplies low voltage to the unit 10 electronics and power for the LED drivers 53. The power factor on the 115 VAC aircraft bus is greater than 0.90 at maximum load. The power factor limits apply to the unit 10 during the operating mode (may be less in standby mode). Exemplary power consumption for various configurations of LED unit size are listed in Table 1 below. Power consumption for other configuration LED unit sizes are listed in Table 2 below. Two power supplies are preferably provided: one low power (˜25 VA) and one high power (˜50 VA), and can be used as required.

TABLE 1
Power Consumption, for Various LED units

| | | Max Power | Design Power |
|---|---|---|---|
| | Length | Consumption | Consumption |
| Type | (mm) | (VA) | (VA) |
| LED unit I | 253 | 18 | 10 |
| LED unit II | 355 | 21 | 14 |
| LED unit III | 457 | 27 | 18 |
| LED unit IV | 542 | 32 | 21 |
| LED unit V | 574 | 34 | 22 |
| LED unit VI | 685 | 40 | 26 |
| LED unit VII | 761 | 44 | 29 |
| LED unit VIII | 874 | 52 | 33 |
| LED unit IX | 914 | 53 | 35 |
| LED unit X | 965 | 56 | 37 |
| LED unit XI | 1066 | 62 | 41 |
| LED unit XII | 1179 | 68 | 45 |
| LED unit XIII | 1179 | 68 | 45 |

TABLE 2
Power Consumption, various LED units

| | | Max Power | Design Power |
|---|---|---|---|
| | Length | Consumption | Consumption |
| Type | (mm) | (VA) | (VA) |
| LED unit I (white F 3000/4000) | 470.6 | 22 | 11 |
| LED unit II (white F 3000/4000) | 623 | 25 | 14 |
| LED unit III | 928 | 39 | 21 |
| (white F 3000/4000) | | | |
| LED unit I (RGBW) | 470.6 | 22 | 11 |
| LED unit II (RGBW) | 623 | 25 | 14 |
| LED unit III (RGBW) | 928 | 39 | 21 |
| LED unit COW I | 470.6 | 22 | 15 |
| (white F 4000) | | | |
| LED unit COW II | 623 | 25 | 18 |
| (white F 4000) | | | |
| LED unit COW III | 928 | 39 | 22 |
| (white F 4000) | | | |

The LED units 10 of different lengths can be built with the same internal building blocks. This architecture is flexible and allows for either color or white LED units of varying lengths to be mated with the appropriate wattage power supply. This also applies to the LED unit XIII units with two ports except this unique two serial port configuration has its own specific integrated control module and power supply which partitions the LED unit into two independent controllable units. The processor executable code is preferably set at the factory and may be uploaded on the aircraft via the communications bus, as applicable.

The LED unit 10 design herein, as briefly noted above, can be comprised of two logical modules, the power supply control module 100 and the LED module(s) 20. The power supply control module 100 does not have to rely on a chassis ground and may use a two-wire design and convert 115VAC 400 Hz to low voltage DC and also house the logic circuitry including the microcontroller 160. This can be encapsulated inside a plastic housing preventing electrical shocks due to the unlikely event of an internal short circuit. The high voltage section of the power supply module can be galvanically isolated from the low voltage DC control circuitry as well as the LED module 20 containing the LEDs 50, drivers 53 and associated hardware. The LED unit can be mounted to an aluminum housing for heat dissipation reasons as well as for LED unit structural performance and integrity. Hence, only low power DC need be supplied from the power supply module 150 to the LED module 20. This design architecture provides better immunity to power line disturbances and related phenomenon such as fast transients resultant from indirect lightning strikes and the like.

To maximize the light output and reduce the perceived color shift during the life of the LED, the LED unit 10 deploys control circuitry and algorithms 160, 190 that ensure the LEDs 50 are operating within manufacturer's specifications. This embodiment provides the LED with a constant current control ensuring appropriate operating conditions for the LED throughout its entire operating range and minimizes the risk of thermal runaway and premature aging. In addition to proper current control, the LED unit 10 may utilize the temperature compensation circuitry 54, 170 that monitors the operating temperature of the LED and adjusts the operating current accordingly if the unit senses that it is beyond the manufacturers' recommended operating temperature.

In an embodiment, the serial communications interface 125 may be based upon CCS and a derivative thereof, and can be based on a two wire physical layer communications protocol such as the EIA/TIA/RS-485 standard. The network wiring architecture can be configured as a distributed star topology, with low voltage 24 AWG two wire “home runs” between each LED unit 10 and controller LC-A 200. A shielded twisted pair cable, can be utilized.

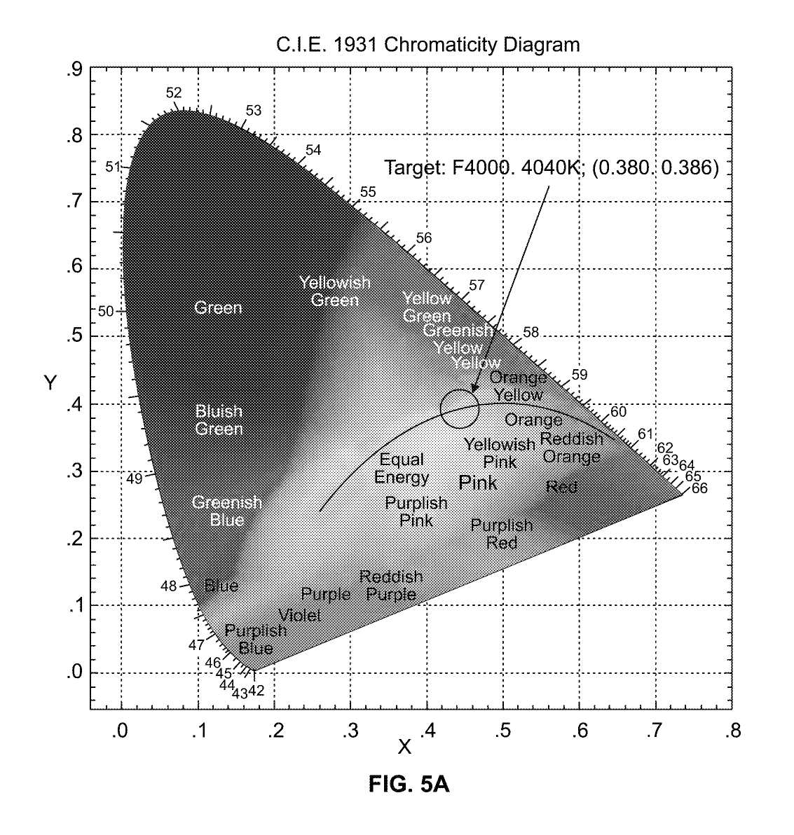

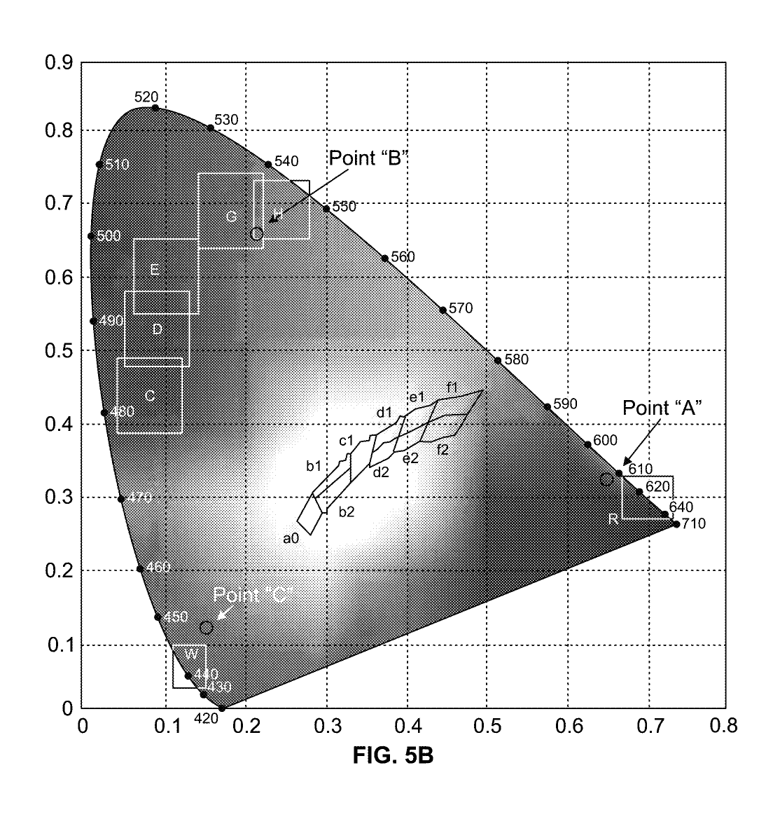

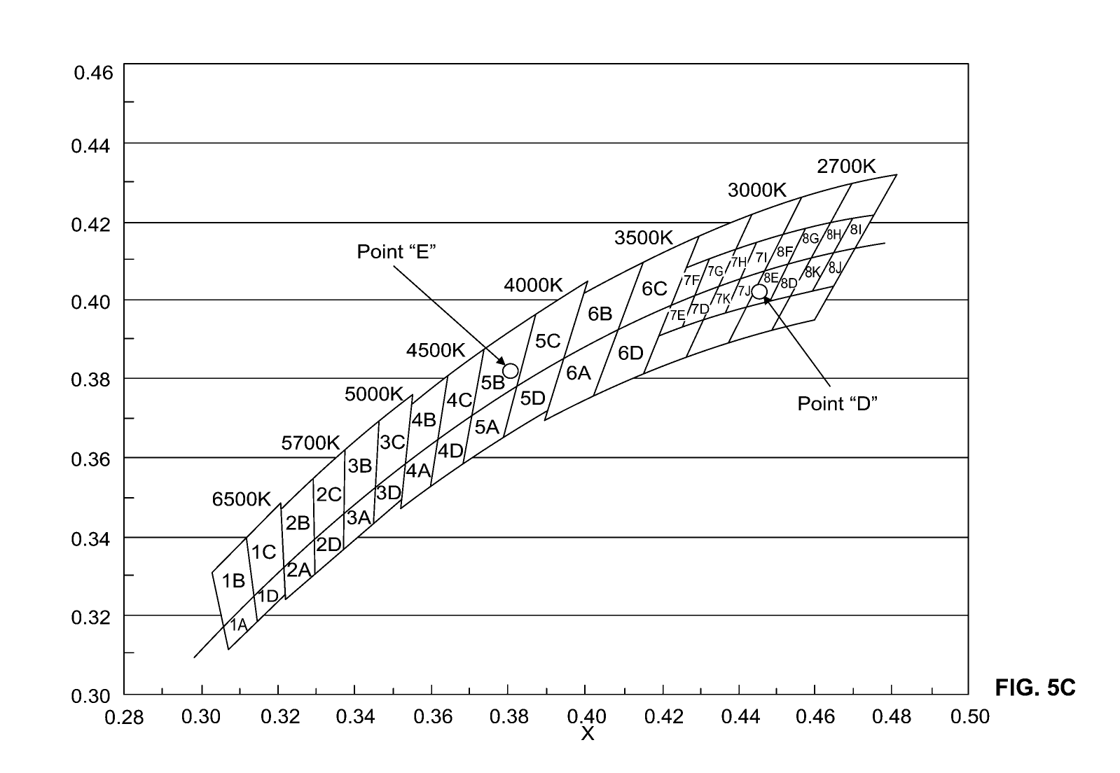

FIG. 5A is a graph, a C.I.E. 1931 Chromaticity Diagram, that is considered in an exemplary embodiment for using white LEDs. In this design, leading edge LED technologies and associated driver circuits and peripherals may be utilized that enable consistent light output and color over the rated life of the product.

A multi-step photometric design approach to product development is utilized, including: application specific LED drive and control architectures, custom LED binning, and proper lensing (as required) of the airplane level component assemblies to ensure the products provide required light output over their lifetime.

By way of example, for such a white-only design, photometric color parameter requirements of an IEC 60081 F4000 LED are CIE 1931 color chart coordinates of X=0.380, Y=0.380 (Point D) and nominal color temperature of 4040 K. This exemplary specification may require custom color binning with the LED manufacturer in order to achieve color consistency. For the this design, LEDs from the Rebel ES family from Lumileds and/or a comparable manufacturer may be used. An ANSI BIN 5B/5C target color point at nominal 4000K with ±263 K tolerance is also possible. In addition, a further refinement of binning and selection could be implemented in the manner described in U.S. Patent Application Ser. No. 61/492,125, filed Jun. 1, 2011, herein incorporated by reference, to keep tight tolerances on the LEDs when calibration is cost prohibitive—this could be used for providing an overall cabin color consistency when incorporating, e.g., spot or reading lights into the system.

The LEDs according to an embodiment currently have a target CRI (approximately 83), which is less than the specification of 85; however, the CRI requirement may be provided for the F 4000 or warmer white colors. White color points may be off the Black-Body Locus and yet still meet a six-step McAdams Ellipse specification and have the variation not be visible on the vehicle. Note that the LED selection and manufacturer listed above are exemplary only.

This design ensures a relatively consistent light output over the lifetime of the unit 10/LRU, based on LED selection and photometric performance. This design may be designed to provide the required illuminance values in the aircraft leveraging current installation requirements and locations. Simulations may be utilized to optimize LRU placement and orientation coupled with LED drive parameters to meet aircraft light level requirements. The photometric light performance for the low cost LED unit COW does not require any secondary lensing as part of the assembly, but such lensing is also a possibility.

As noted above, this design may be retrofitted into the same mechanical locations and utilize the same electrical infrastructure, including connectors and cables, as the existing lighting LRUs. More specifically, the connectors, including locations and pin-out, are intended to mate with the existing ones. This design can employ the appropriate and necessary thermal management including the use of heat extracting materials, such as aluminum housing, heat fins, and thermal transfer pads as required. Thermal modeling and testing may be used to ensure compliant thermal behavior of the unit 10. All metallic parts may be protected against corrosion through treatment such as using ChemFilm per MIL standards.

The unit 10 should be operational during following flight phases: Ground, Start, Roll, Take off, Climb, Cruise, Descent, Land, Taxi, and should be operable during the entire daily operating hours of the aircraft (approx. 20 h powered).

There are three main operating modes of the white-only unit 10: 1) Dim mode—continuous, perceptible virtual stepless dimming, between 0.1% and 100% of the luminance channels; 2) Bright mode—remaining aircraft daily operation hours (100% light output); and 3) Scenario mode—constant dynamic changes of luminance. In a preferred embodiment, where costs are a concern, the LED unit 10 does not have dynamic scenes with specific color information (color/intensity) stored within its memory, and simply responds to commands from the controller LC-A 200. However, dynamic scene information could also be stored within the white-only unit 10, and it could respond to higher level commands. It is preferable that there is no perceptible or harmful flickering, light pulsation or light interaction between different light units at any operating time and operating mode.

The dim curve according to human perceptibility for all illumination applications in the cabin may be implemented in the CCS-Data Protocol. The ramp time/rise time (with constant slope) between 0% and 100% brightness is preferably around 8 seconds. This rise/fall time may be applicable and equal for all physical light sources of a unit 10.

In the case of “loss of communication” from the CCS for equal to or greater than, e.g., 60 seconds, the LED unit 10 can change over to its default illumination and operational values. These are pre-defined values generally stored in the equipment and are specified as 100% illuminance, although such a default value could be set to 50% or less due the possible undesirable state and passenger experience that may result during a night flight. After CCS resumes the communication, the LED unit 10 can revert to the dim level settings transmitted by CCS.

The unit 10 preferably includes hardware and software to allow a software loading in the aircraft via CCS. The unit 10 may be controlled via the CCS by way of a serial interface to controller LC-A 200.

One discrete input with floating ground (wire strap) may be included to change the fail safe mode (in case of CCS communication loss for, e.g., more than 60 seconds) from 50% brightness to 0% brightness. The dim and setting commands may be transferred as a data protocol order between controller LC-A 200 and the unit 10.

For color LED units 10, a wide resultant LED color gamut is supported. As part of this, custom LED binning can be used to leverage relationships with key LED manufacturers and suppliers. A modified binning solution may be utilized to provide the color gamut defined by the current LED color specification points.

FIGS. 5B and 5C illustrate exemplary color gamut points. FIG. 5B is a standardized color gamut chart according to CIE 1931. FIG. 5C is a standardized ANSI White Bins map.

In FIG. 5B, the following color points are provided:
Red—The photometric color coordinates of X=0.650, Y=0.325 (Point A) are illustrated in this Figure.
Green—The photometric color coordinates of X=0.230, Y=0.650 (Point B) is provided. Other binning structures (C, D, E, and G) are shown for other possible solutions if required.
Blue—The photometric color coordinates of X=0.160, Y=0.130 (Point C) are illustrated in this Figure.

In FIG. 5C, the following white points are provided:
Cool White—The photometric color coordinates of X=0.440, Y=0.403 (Point D) are provided using custom color binning with the LED manufacturer.
Warm White—The photometric color coordinates of X=0.380, Y=0.380 (Point E) are provided using custom color binning with the LED manufacturer.

In an embodiment, a typical CRI of 85 for the warm white and cool white color configurations can be provided.

Device level calibration of the airplane level assemblies may be utilized to ensure consistent light and color output over its lifetime. This is accomplished by the use of firmware, algorithms, hardware, and production calibration to address LED aging and color shift. More specifically, photometric test equipment is also contemplated herein that is utilized in conjunction with proprietary software to adjust the color temperature x, y, points, and luminous intensity of each lighting unit during final test. The result is repeatable light output from unit to unit and shipset to shipset.

The intensity and uniformity of the light output distribution can be controlled via the LED unit 10 control circuit 160, LEDs 50, associated embedded system, and necessary lens techniques for each application. The LED unit 10 is preferably designed to maintain uniform color saturation and brightness on an illuminated surface at a reasonable distance. The total light output should be optimized wherever possible to illuminate the ceiling and side wall panels of the aircraft with the intention to provide a uniform light distribution.

The LED unit 10 is preferably designed to be retrofitted into the same mechanical locations and utilize the same electrical infrastructure, including connectors and cables, as the existing traditional lighting LRUs. More specifically, the connectors, including locations and pin-out, are ideally intended to mate with the existing ones. The LED unit 10 can employ the appropriate and necessary thermal management including the use of heat extracting materials, such as aluminum housing, heat fins, and thermal transfer pads, as required. Thermal modeling and testing is ideally used to ensure compliant thermal behavior of the LED unit 10. All metallic parts are preferably protected against corrosion through treatment such as using ChemFilm per MIL standards.

The LED unit 10 is preferably comprised of several main modules: the rigid aluminum extrusion that houses the LED unit and circuitry, the power supply control module that contains the AC to DC conversion circuitry as well as the digital control circuitry, and the aircraft interface cable with connector for power and communications. The mechanical design should preferably accommodate two different power supply requirements; one low power (˜25 VA) and one slightly larger high power (˜50 VA) module. The LED unit is designed to be retrofitted into the same mechanical locations as the existing lighting LRUs. The proposed LED unit mounting bracketry is designed for easy installation and removal into/from the existing aircraft lighting LRU mounting points.

The LED unit 10 is preferably designed to ensure that the mechanical interface to the aircraft is independent from the installation environment and equal for each length of LED unit 10. Each variant can provide a variety of attachment points as necessary, and the appropriate electrical and mechanical keying as allowed by the aircraft system interfaces can be provided to minimize the LED unit from being installed in an incorrect position or orientation, or an incorrect electrical bus.

Various tests may be performed on production standard units 10. Light measurement tests can be defined and run before and after the set of environmental tests to check for changes in light distribution and intensity while the unit is operating at its normal supply voltage. The following tests may be performed.

TABLE 3
Environmental Test Requirements and Approaches
Environmental Requirement

Temperature: Operational Conditions
Temperature: Start-up After Ground Soak at High/Low
Temperature: Ground Survival Temperature
Atmospheric Pressure: Steady State
Atmospheric Pressure: Decompression
Atmospheric Pressure: Overpressure
Temperature Variation
Humidity
Shocks and Crash Safety: Operational
Shocks and Crash Safety: Crash Safety
Vibration: Operational
Vibration: Engine Fan Blade Loss
Waterproofness
Fluid Susceptibility, including cleaning and extinguishing agents
Flammability/Toxicity/Smoke/Gas Emission
Electrical: Power Consumption, Power Factor, Inrush Current
Electrical: Dielectric and Insulation Resistance
Lightning: Indirect Effects
Lightning: Damage Effects
Functional Event Upset
RF Susceptibility: Five tests
RF Emissions: Two Tests
Electrostatic Discharge
Noise

The LED unit light output can be measured as a confirmation of proper LED unit operation during a test. For tests that affect the LED unit's physical or electrical environment, a PC or simulation support equipment can be connected to the LED unit and send normal serial messages to the units under test.

In one embodiment of a system, three different types of LED units can be provided: a) Warm White (F 3000); b) Cool White (F 4000); and c) Full Color (RGBW). The minimum illumination level should be 80 Lux @ F4000 color acc. IEC 60081 at the floor level of the aircraft. The LED unit XIII (1179 mm) two-port variant should be equipped with technical components in order to partition the LED unit 10 into two independent controllable units via two times serial interfaces. The LED unit mainly comprises the electronic part including an interface to CCS and including a current source for the LED and a light control part (luminance, color). The design provides the equivalent control of colors and light using calibration. The calibration consists of various algorithms and hardware.

The following defines additional optional characteristics according to one or more embodiments of the system. The LED unit 10 may include components for power factor control. The LED unit 10 may include BITE and one or two serial data interface(s) to the controller LC-A 200. The LED unit 10 may be equipped with technical components in order to prevent damage of the unit/components, due to overheating, resulting from malfunction of the LED unit 10 and/or LED part. An LED unit 10 variant may be equipped with technical components in order to partition the LED unit 10 into two independent controllable units via two times serial interfaces. The boundary itself may be marked by a 100 mm wide dark (all LEDs off) section. The LEDs of the LED unit may be driven and operated using DC signals or PWM signals of at least 150 Hz to avoid flicker effects. Feedback elements may be used to stabilize light output and color of the LEDs over the lifetime to compensate any impact of aging, temperature, LED tolerances and other parameters.

The following LED Color Gamut may be utilized:

| | | | | |
|---|---|---|---|---|
| | | | | Color Rendering |
| IEC 60081 | Color Temp | x-coord | y-coord | Index |

Warm White (F 3000)

| | | | | |
|---|---|---|---|---|
| F 3000 | 2940 k | 0.440 | 0.403 | ≧90 |

Cool White (F 4000)

| | | | | |
|---|---|---|---|---|
| F 4000 | 4040 k | 0.380 | 0.380 | ≧90 |

The LED part of the LED unit may use at least four different primary colors. The LED part of the LED unit may exceed the following accessible virtual color gamut: Red: xr=0.650 yr=0.325 (Reference Space: CIE1931, 2 deg. Observer). The LED part of the LED unit may exceed the following accessible virtual color gamut: Green: xg=0.230 yg=0.650 (Reference Space: CIE1931, 2 deg. Observer). The LED part of the LED unit may exceed the following accessible virtual color gamut: Blue: xb=0.160 yb=0.130 (Reference Space: CIE1931, 2 deg. Observer). The LED part of the LED unit may exceed the following accessible virtual color gamut: White: xb=0.380 yb=0.380 (Reference Space: CIE1931, 2 deg. Observer). The Equipment Supplier may state the physical color coordinates of the LED groups and the types of LEDs used.

Regarding color tolerances, the LED part of the LED unit 10 may be designed to fulfill the following color tolerance requirements: max. 1.5 SDCM ellipse (radius) between any two LED units. (SDCM: Standard Deviation of Color Matching, ref: MacAdam Ellipses). The common understanding of this requirement is that the tolerance of the color coordinates may be less than 3 SDCM (diameter) between any two LED units.

The Color Rendering Index (CRI) of the [Full Color (RGBW)] LED unit may be equal or better than 90 between 2700K and 6500K for white light. The Color Temperatures may be stepless variable on the Black-Body Locus.

The minimum illumination level may be 80 Lux [for all variants (Full Color RGBW)] @ F4000 color acc. IEC 60081 at floor level of the aircraft.

The light distribution characteristic of the LED unit 10 may be sufficient to maintain uniform color saturation and brightness on an illuminated surface. The human capability to just distinguish different shades of saturation may be used as the criterion. The LED unit may be designed in a manner that colored light mixed from the primary colors of the LEDs generate a uniform color appearance on an illuminated surface. The human capability to just distinguish different shades of color may be used as the criterion. In general, the total light distribution may be optimized to illuminate ceiling and side wall panels of the vehicle. Scattered light towards any direction is preferably avoided.

The output color and luminance of the LED unit may be controllable via CCS. The step response time between any two consecutive dim steps may be 0.4 s±0.1 s. This rise/fall time may be applicable and equal for all physical light sources of a LED unit. In the case of “loss of communication” from the CCS for equal to or greater than 60 seconds the LED unit may change over to its default values. Table 2-2 is an exemplary Fail Safe Truth Table.

TABLE 2-2
Fail Safe Truth Table

| Fail Safe Mode | Discrete input “Fail Safe 0%” | Dim Level |
|---|---|---|
| OFF | NO | Defined by CCS |
| OFF | YED | Defined by CCS |
| ON | NO | Default Value |
| ON | YES | 0% |

After CCS resumes the communication the LED unit may revert to the dim levels and color settings transmitted by CCS. The LED unit may include hardware and software to allow a software loading in the vehicle via CCS. Equipment fitted with pin programming may be designed such as a single point failure will not produce the erroneous selection of misleading configuration (program, data base, control laws, logic, etc.). One discrete input with floating ground (wire strap) may be included to change the Fail Safe mode (in case of CCS communication loss >60 sec) from 50% brightness to 0% brightness. The dim and color setting commands may be transferred as data protocol order between the controller LC-A 200 and LED unit 10. The LED unit XIII two-port variant may provide 2 CCS—LC-A ports. The equipment powered by 115 VAC (400 Hz) may be supplied via isolation transformer from primary 115 VAC aircraft power supply and a switching AC/DC converter as part of the equipment. The equipment should be full functioning in case of a power drop down to 93 VAC. The equipment may or may not have internal power supplies for back-up, e.g., batteries.

The table below specifies exemplary maximum masses of all variants of LED unit.

| Equipment | Maximum Mass [kg] |
|---|---|
| LED unit I | 0.584 |
| LED unit II | 0.620 |
| LED unit III | 0.656 |
| LED unit IV | 0.685 |
| LED unit V | 0.697 |
| LED unit IV | 0.736 |
| LED unit VII | 0.762 |
| LED unit VIII | 0.802 |
| LED unit IX | 0.816 |
| LED unit X | 0.834 |
| LED unit XI | 0.869 |
| LED unit XII | 0.908 |
| LED unit XIII (2 × serial interface) | 0.908 |
| LED unit I (warm white F3000) | 0.380 |
| LED unit II (warm white F3000) | 0.400 |
| LED unit III (warm white F3000) | 0.430 |
| LED unit I (cool white F4000) | 0.380 |
| LED unit II (cool white F4000) | 0.400 |
| LED unit III (cool white F4000) | 0.430 |
| LED unit I (RGBW) | 0.380 |
| LED unit II (RGBW) | 0.400 |
| LED unit III (RGBW) | 0.430 |

All electromagnetic components (e.g. coils, relays, inductors, actuators, pumps, motors, etc.) may be fitted with protection devices to minimize the generation of voltage transients during their operation. These protection devices may be selected to ensure that these transient voltages do not damage any sensitive control and switching circuits.

The LED unit 10 may be protected against ESD. The LED unit should not be susceptible to voltage spikes, which are expected in the system caused by Indirect Lightning Effects. Installation and changing of all components should may be possible without the use of any special tools. A faulty line-replaceable unit (LRU) may be detectable by A/C built-in test equipment (BITE) (via the CCS data bus).

BITE history (previous LRU failures and reconfiguration history with their associated dates and flight hours) may be accessible during shop test, storable for statistical analysis. If refresh messages are not received within sixty seconds from the controller LC-A 200, the LED unit 10 may default to predefined settings. Data discrepancy can be checked against the CRC of the communications protocol. BITE failures may be sent to the controller LC-A 200 for failure reporting to the CMS. A watchdog can be used to force a reset for critical software problems. If tracking of flight hours or date is necessary, a real time clock can be added to the LED unit 10 which may necessitate a battery.

The an embodiment of the LED unit 10 solution provides built-in tests (BIT) that provide the minimal commonly accepted coverage and is comparable to that of the existing fluorescent lighting units. This includes CRC checking, temperature sensors, a watchdog timer, and RAM checksums. The LED unit also provides BITE functionality which is accessible via the serial communications bus. BITE functions include event history logging, version reporting, and certain other monitoring points. During operation, the LED unit 10 performs the BIT and BITE functions. The LED unit 10 may then report these results when polled for such by the controller LC-A 200. When polled, the LED unit 10 processor reports its current health state by retrieving these stored results. Maintenance personnel can review reports from all LED unit equipment using the access panel 220 to access corresponding readouts.

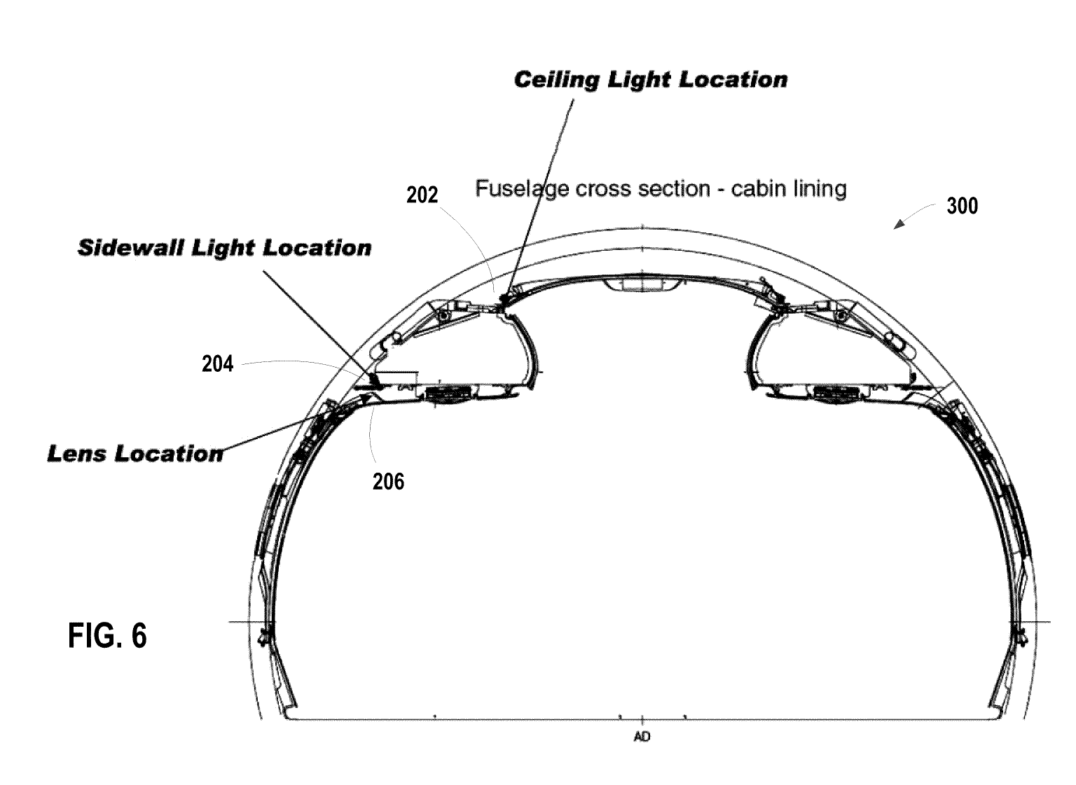

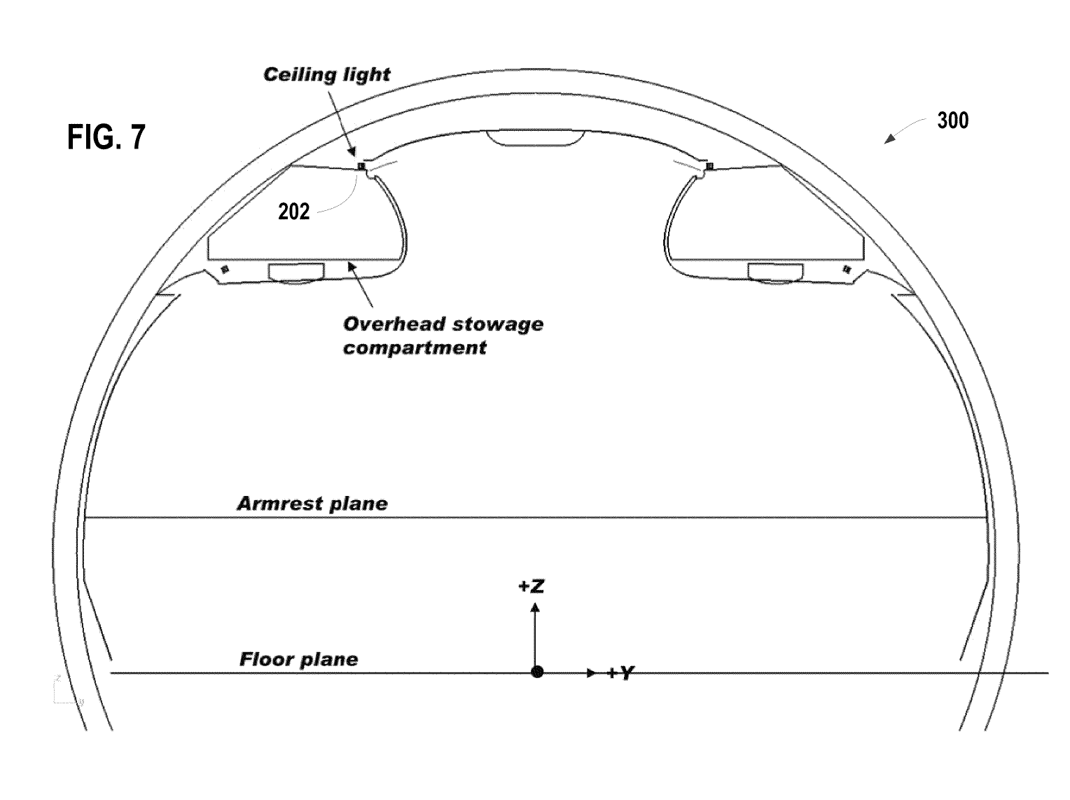

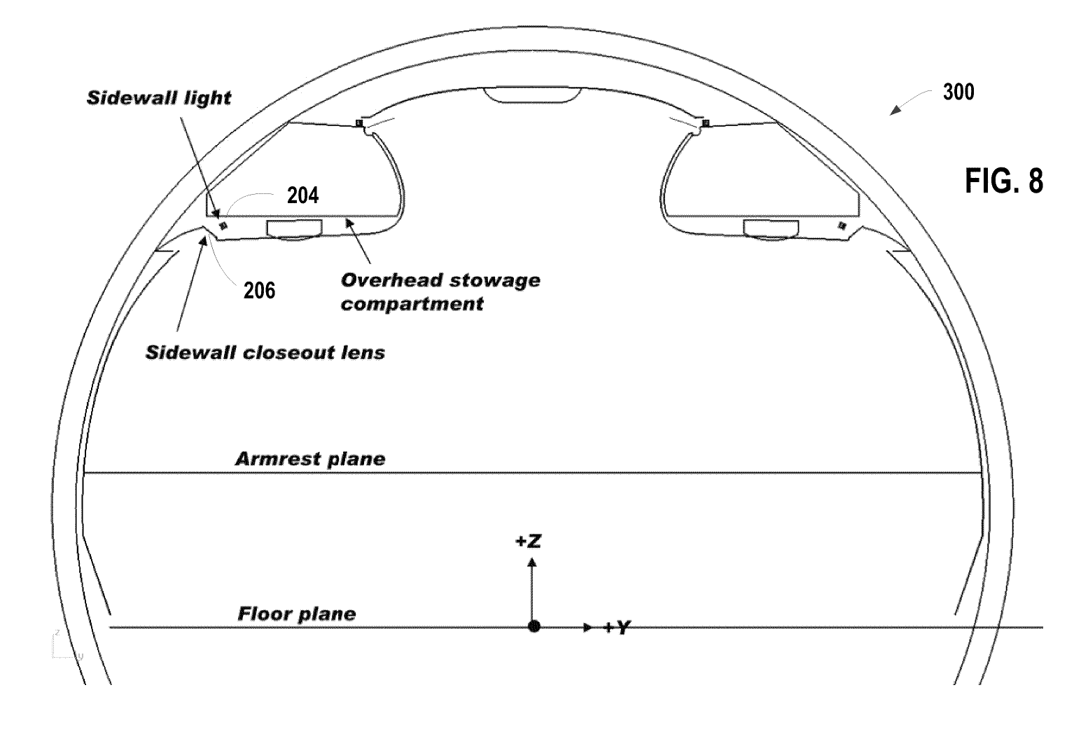

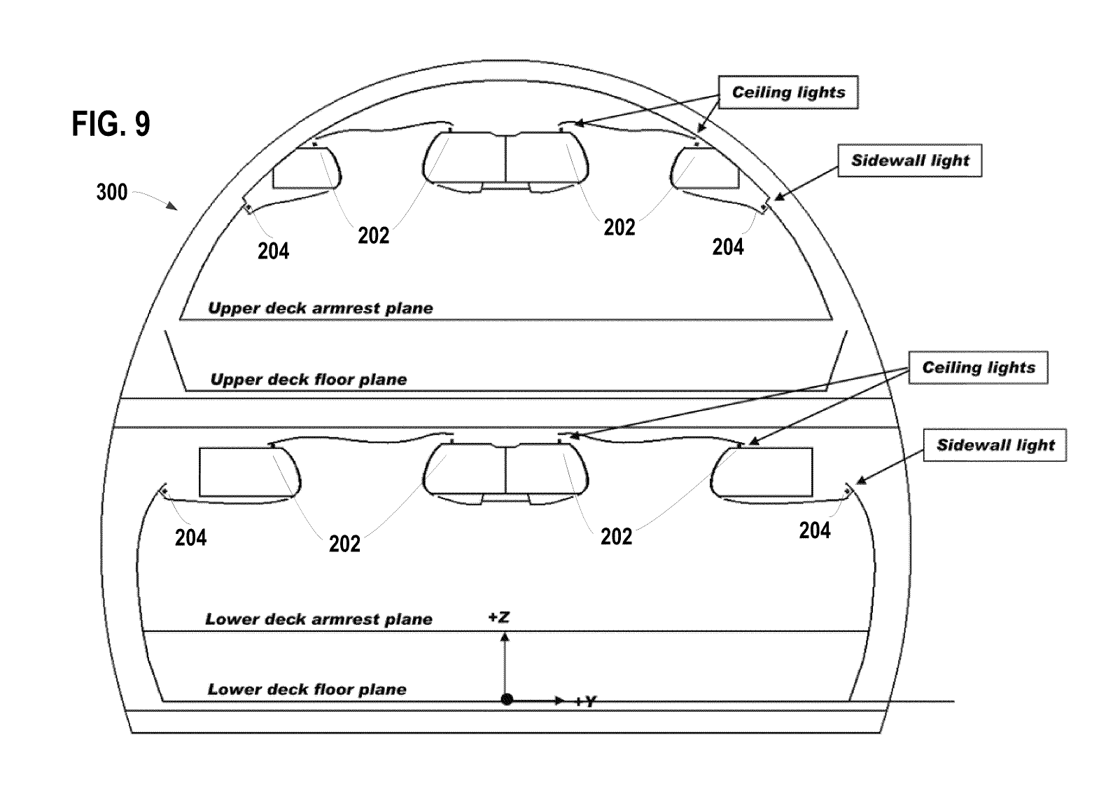

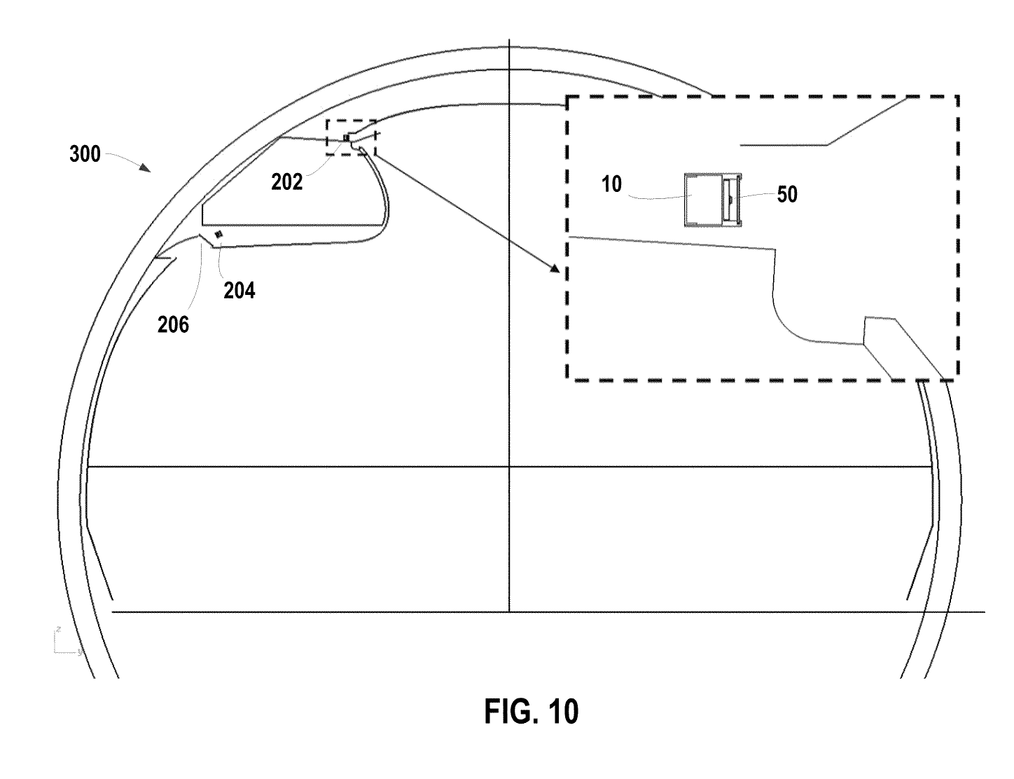

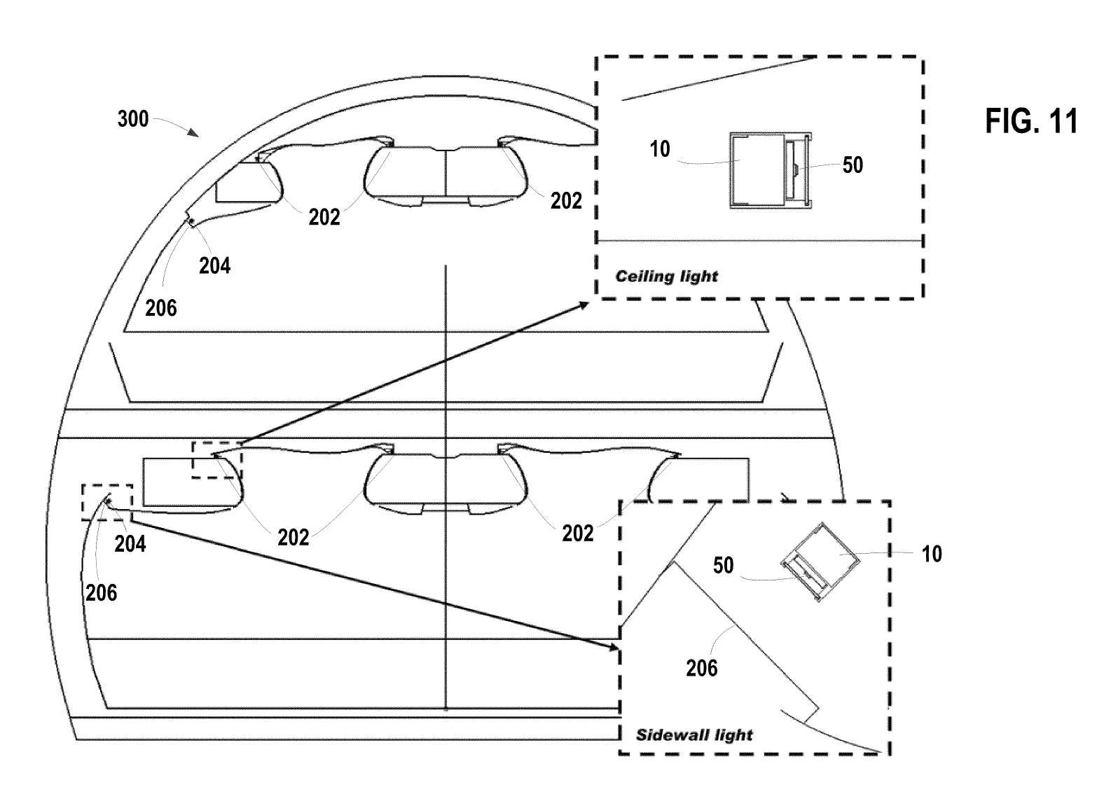

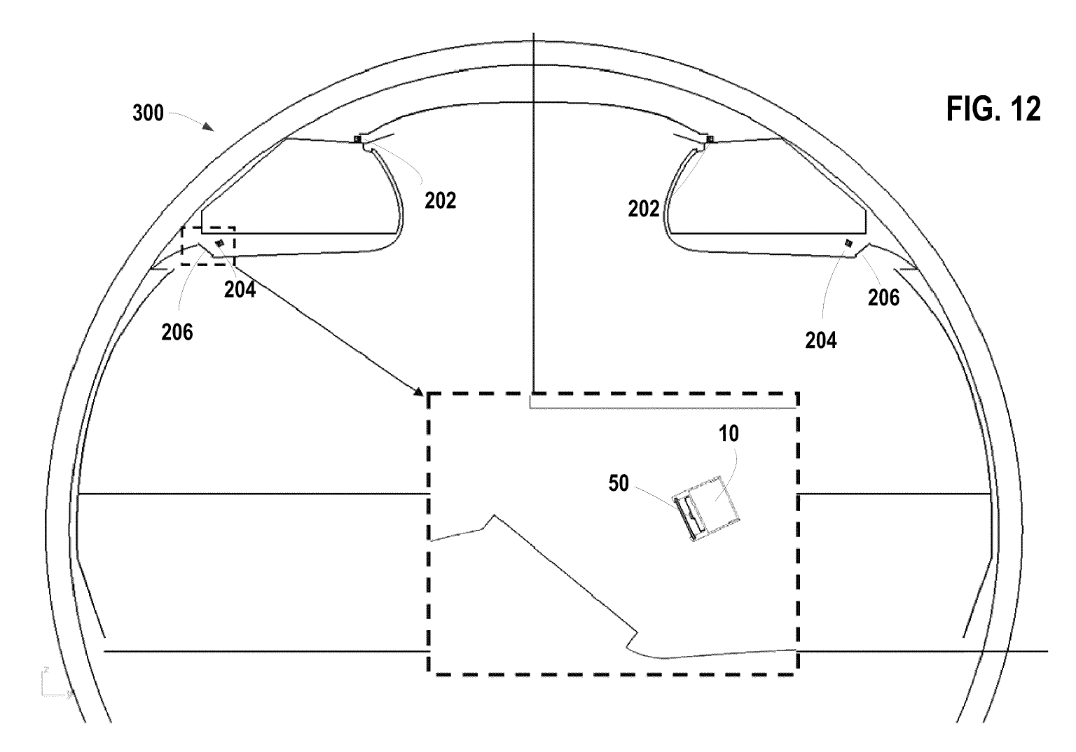

FIGS. 6-12 illustrate various lighting locations in various cross sectional shapes of an airplane fuselage 300. By placing the LED units 10 at these locations, a uniform and well-distributed illumination throughout the vehicle can be achieved.

Referring to these figures, ceiling 202 and sidewall lights 204 are provided using RGBW or W LED units 10. In a preferred embodiment, a clear cover lens plus a diffuse closeout lens 206 for sidewall lights 204 only are provided.

In an exemplary configuration, three 13-inch long devices per LRU, eight 39-inch long LRUs per aircraft side, a “Warm White” (32) setting, Red=0.4, Blue=0.3, Green=0, White=5.9 (×2) lumens, and an RGBW-W quintuple=12.5 lumens are provided. In an exemplary test, simulated RGBW-W devices had 12.5 lumens for each group of five LEDs. The illuminance from ceiling and sidewall lights combined ranges from 150 Lux at the walls to 85 Lux in the center of the aircraft.

The Figures also portray a configuration for sidewall lights, using RGBW-W LED boards, clear cover lens plus diffuse closeout lens, three 13-inch long devices per LRU, eight 39-inch long LRUs per aircraft side, “Warm White” (32) setting, Red=0.4, Blue=0.3, Green=0, White=5.9 (×2) lumens, RGBW-W quintuple=12.5 lumens, simulated RGBW-W (12.5 lumens for each group of five LEDS) sidewall lights with diffuse closeout lens, where illuminance from sidewall lights only is approximately 80 of Lux near the wall on the floor.

The Figures also portray a configuration for ceiling lights using RGBW-W LED boards, clear cover lens, three 13-inch long devices per LRU, eight 39-inch long LRUs per aircraft side, “Warm White” (32) setting, Red=0.4, Blue=0.3, Green=0, White=5.9 (×2) lumens, and RGBW-W quintuple=12.5 lumens. The illuminance from ceiling lights only is approximately 60 lux in the center of the aisle on the floor.

The system or systems described herein may be implemented on any form of computer or computers and the components may be implemented as dedicated applications or in client-server architectures, including a web-based architecture, and can include functional programs, codes, and code segments. Any of the computers may comprise a processor, a memory for storing program data and executing it, a permanent storage such as a disk drive, a communications port for handling communications with external devices, and user interface devices, including a display, keyboard, mouse, etc. When software modules are involved, these software modules may be stored as program instructions or computer readable codes executable on the processor on a computer-readable media such as read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

Numerous modifications and adaptations will be readily apparent to those skilled in this art without departing from the spirit and scope of the present invention.

TABLE OF REFERENCE CHARACTERS

| | |
|---|---|
| 10 | LED unit |
| 20 | LED module |
| 30 | housing |
| 50 | LED |
| 52 | LED string |
| 53 | LED driver |
| 54 | temperature sensor |
| 60 | LED control bus |
| 65 | peripheral control bus |
| 100 | power supply and control module |
| 120 | module connector |
| 122 | module connector cable |
| 125 | serial bus |
| 130 | attachment element |
| 140 | line voltage/bus |
| 145 | isolation barrier |
| 150 | power supply module |
| 160 | microcontroller |
| 170 | temperature sensor |
| 185 | connector/interface |
| 190 | LED drive control |
| 200 | lighting controller LC-A |
| 202 | ceiling lights |
| 204 | sidewall lights |
| 206 | lens |
| 210 | arbitrator |
| 220 | access panel |
| 250 | CCS data bus |
| 300 | aircraft fuselage |
| 302 | vehicle mounting elements |
| 310 | vehicle generator |
| 312 | vehicle circuit breaker panel |

What is claimed is:

1. A light emitting diode (LED) unit, comprising:
an LED module, comprising:
a plurality of LEDs;
LED drive circuitry that drives the LEDs;
an LED control bus that carries LED illumination control information to the LED drive circuitry; and
a housing that at least partially surrounds LED module components;
a power supply and control module, comprising:
a power supply that converts a first voltage level to a second voltage level;
a microcontroller that receives illumination instructions from an external source;
an LED drive controller that receives lighting instructions from the microcontroller and transmits LED illumination information to the LED drive circuitry;
a housing that at least partially surrounds power supply and control module components;
an interface that connects the LED drive controller to the LED control bus.

2. The LED unit of claim 1, further comprising:
a temperature sensor that provides temperature information to the microcontroller.

3. The LED unit of claim 2, wherein:
the microcontroller comprises temperature compensation information and software for maintaining a temperature independent brightness and color of the LEDs.

4. The LED unit of claim 2, wherein:
the microcontroller comprises software for reducing power to the LEDs if an overtemperature condition is detected.

5. The LED unit of claim 2, wherein:
the temperature sensor is located proximate the LED drive circuitry to measure its temperature.

6. The LED unit of claim 5, wherein the LED module further comprises:
a peripheral control bus that connects the temperature sensor to the microcontroller.

7. The LED unit of claim 1, further comprising:
an additional LED module that is powered by the power supply and control module; and
an LED module connector that connects the additional LED module to the LED module.

8. The LED unit of claim 1, further comprising:
a datastore that stores calibration information for LEDs obtained during testing prior to installation of the LED unit.

9. The LED unit of claim 1, wherein:
the LED unit is configured to read information from the external source that is an external controller and connected to a cabin communication system (CCS).

10. The LED unit of claim 9, wherein an RS-485 interface is provided between the external controller and the LED unit.

11. The LED unit of claim 1, wherein the power supply and control module comprises an isolation barrier that electrically isolates the power supply first voltage level from the second voltage level.

12. A vehicle LED illumination system, comprising:
a plurality of LED units, as claimed in claim 1;
wherein a plurality of the LED units are controlled by a single external controller that is connected to a cabin communication system (CCS).

13. The illumination system of claim 12, wherein at least two of the LED units have a different size.

14. The illumination system of claim 12, further comprising:
a access panel and an arbitrator that connects to the external controller and permits a user to control the LED units within the system.
